(19) United States
(12) Patent Application Publication
(10) Pub. No.: US 2002/0008609 A1
(43) Pub. Date: Jan. 24, 2002

(54) Electronic frame lock

(76) Inventors: Wei-Kang Lin, Taipei (TW); Chih-I Lin, Chino Hills, CA (US); Shih-Yu Tsou, Taipei (TW); Sheng Fu Lin, Taipei (TW)

Correspondence Address: BACON & THOMAS, 4th Floor, 625 Slaters Lane, Alexandria, VA, 22314, US

(21) Appl. No.: 09/753,449

(22) Filed: Jan. 4, 2001

(30) Foreign Application Priority Data
Jun. 12, 2000 (TW) 89221206

(51) Int. Cl. H04Q 1/00; G06F 7/00

(52) U.S. Cl. 340/5.64

(57) ABSTRACT

An electronic frame lock includes an electronic lock and an electronic key. The electronic lock is formed of a controller, a motor, and an insertion pin. The motor receives a control signal from the controller, so as to pull or push the insertion pin to bring about the unlocking or locking effect. The electronic key transmits a signal to the controller of the electronic lock. As the signal is compared and verified by the controller, the motor is started to pull the insertion pin, so as to unlock the electronic lock.

### FIELD OF THE INVENTION

The present invention relates generally to an electronic frame lock, and more particularly to a noncontact electronic frame lock.

### BACKGROUND OF THE INVENTION

The conventional frame lock is mechanically operated and is defective in design in that the combination is limited in number, and that additional locks are often needed. In addition, the conventional frame lock is not provided with a means to record the time at which the lock is unlocked, or the name of the patrol. Furthermore, the conventional frame lock is not provided with an alarm. Even if the conventional frame lock is provided with an alarm, the origin of the alarm signal can not be easily identified. ISP/ASP can not be easily managed.

### SUMMARY OF THE INVENTION

It is the primary objective of the present invention to provide an electronic frame lock.

It is another objective of the present invention to provide a noncontact electronic frame lock.

It is still another objective of the present invention to provide an electronic frame lock comprising an electronic lock and an electronic key. The electronic lock is formed of a controller, a motor, and an insertion pin.

### BRIEF DESCRIPTION OF THE DRAWINGS

FIG. 1 shows a block diagram of the electronic frame lock of the present invention.

FIG. 2 shows a block diagram of a preferred embodiment of the present invention.

FIG. 3 shows a process flow diagram of the preferred embodiment of the present invention.

### DETAILED DESCRIPTION OF THE EMBODIMENTS

The present invention comprises an electronic lock and an electronic key.

The electronic lock is formed of a controller, a motor, and an insertion pin. The motor receives a control signal from the controller, so as to pull or push the insertion pin to attain the function of unlocking or locking the electronic lock.

The electronic key is used to transmit a signal to the controller of the electronic lock. Upon completion of comparison of the signal by the controller, the motor of the electronic lock is started to pull the insertion pin, thereby resulting in the unlocking of the electronic lock.

The controller of the electronic lock comprises a read device, a central processing unit (CPU), a memory, and a control loop, wherein said read device, said memory, and said control loop are connected to said central processing unit (CPU). The read device may be a self-designed read device or a read device that is purchased from the market, such as IFD 4001 Contactless card reader. The central processing unit may be redesigned or purchased from the market, such as 8051. The memory may be any type of memory, such as EEROM. The size of the memory depends on the need of the user, such as 64K or 239K. The control loop may be the conventional circuit or integrated circuit, such as ROHM BA6218.

If necessary, the controller is connected with a computer or similar device via a transmission unit for attaining the function of automatic recording of locking and unlocking and/or patrol. Preferably, said central processing unit of the controller is externally connected with a computer or a device similar to the computer via a transmission unit. The transmission unit is any conventional transmission unit, such as RS-485 or RS-232.

The motor of the present invention is a conventional motor. The insertion pin of the present invention is a conventional insertion pin. When the electronic frame lock is in the locking state, the insertion pin is pushed by the motor into the lock hole of the frame or the housing lock hole of the frame. When the electronic frame lock is in the unlocking state, the insertion pin is pulled out of the lock hole by the motor.

The electronic key cooperates with the reader of the controller, as shown below:

| Reader | Electronic Key |
|---|---|
| Magnetic card, reader | Magnetic bar card |
| RF-ID | RF-ID card |
| Intelligent card reader | Intelligent card |
| Card reader | Punch card |
| Bar code reader | Bar code card |

Preferably, the electronic key and the reader of the present invention cooperate in a contactless fashion, which can be attained by the radio-frequency identification system. The cooperating mode may be one electronic lock-one electronic key, one electronic lock-multiple electronic keys, one electronic key-multiple electronic locks, and the like. Each of the electronic lock and the electronic key has an identification code for recording.

The records of locking/unlocking/patrolling are stored in the memory of the electronic lock, or a computer which is externally connected. The recording is thus done in an automatic manner. The recording contents include person, time and place, wherein the place is the identification code of the electronic lock. The recording is done by the conventional recording mode, such as the real time recording, or the command recording.

The electronic frame lock of the present invention may be provided with an add-on alarm or externally-connected alarm. The alarm may be directly connected with the central processing unit such that the alarm becomes an integral part of the controller. The alarm may be externally connected with the central processing unit or computer. As the alarm emits a signal, the time and the place of the signal are recorded or displayed.

Preferably, the present invention comprises a housing for containing the controller, the motor, and the insertion pin. The housing enables the present invention to be fastened securely with the frame.

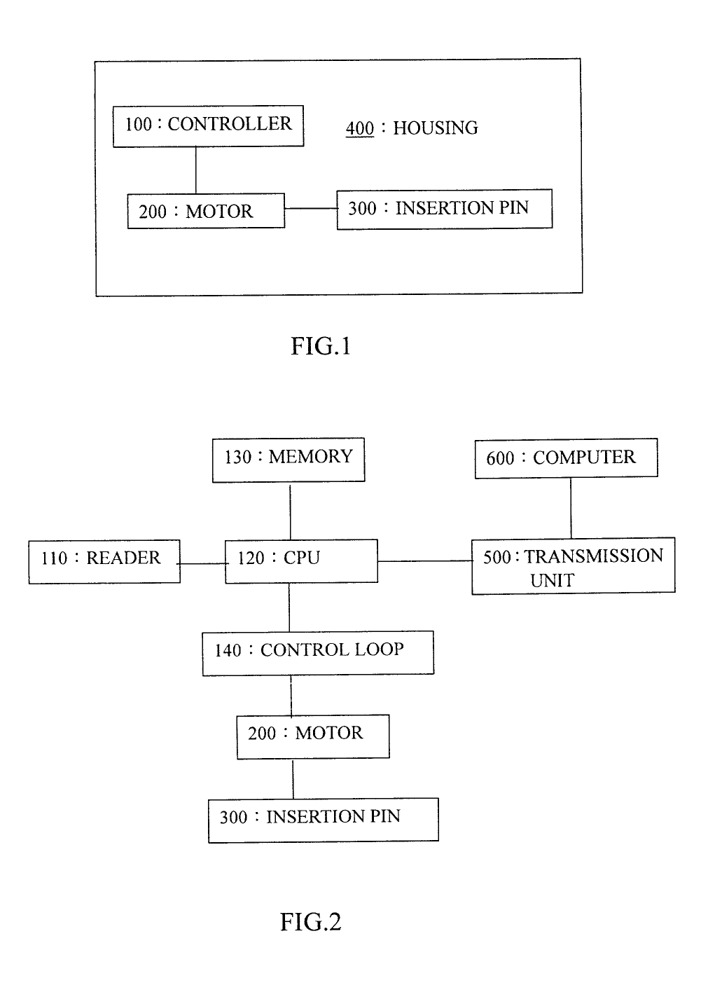

FIG. 1 shows a block diagram of the electronic frame lock of the present invention. As shown in FIG. 1, 100, 200, 300, 400 denote respectively the controller, the motor, the insertion pin, and the housing. The housing 400 is to be fixed on a frame, and contains the controller 100, the motor 200 and the pin 300. The housing 400 is provided with a lock hole to allow the motor 200 to pull the pin 300 away from the lock hole or push the pin into the lock hole, so as to bring about the locking-unlocking effect.

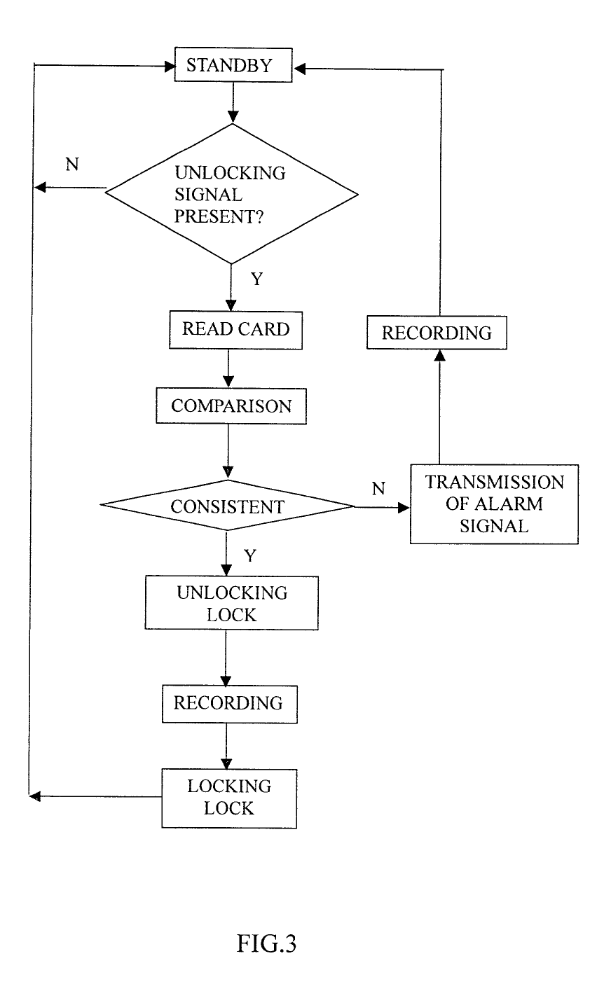

FIG. 2 shows a block diagram of a preferred embodiment of the present invention. As shown in FIG. 2, 200 and 300 are similar in definition to those of FIG. 1. 110, 120, 130, 140 denote respectively the reader of the controller, the CPU, the memory, and the control loop, wherein said central processing unit 120 is connected with said reader 110, said memory 130 , and said control loop 140. The CPU 120 is further connected with a computer 600 via a transmission unit 500 (RS-485). The locking-unlocking operations are shown in FIG. 3.

As shown in FIG. 3, under the normal circumstance, the electronic frame lock is ready as a standby. In the presence of the unlocking signal, the reading and the comparing of the signal are done. If the comparison of the signal is inconsistent, an alarm signal is transmitted. In the meantime, the time and the identification code of the electronic lock receiving the unlocking signal are recorded. If the comparison outcome is legitimate, the CPU sends out a signal to start the motor to pull back the insertion pin, so as to unlock the electronic lock. In the meantime, the data of the person unlocking the lock, the unlocking time, and the identification code of the electronic lock are automatically recorded.

What is claimed is:

1. An electronic frame lock comprising:
an electronic lock comprising a controller, a motor, and an insertion pin, said motor being used to receive a control signal from said controller such that said insertion pin is pulled or pushed by said motor, thereby resulting in an unlocking effect or a locking effect; and
an electronic key for transmitting a signal to said controller of said electronic lock such that the signal is compared and verified by the controller before said motor is started by the verified signal to pull said insertion pin so as to unlock said electronic lock.

2. The electronic frame lock as defined in claim 1, wherein said electronic lock further comprises a housing for mounting said electronic lock on a frame and for containing said controller, said motor, and said insertion pin.

3. The electronic frame lock as defined in claim 1, wherein said controller comprises a reader, a central processing unit, a memory, and a control loop, wherein said central processing unit is connected with said reader, said memory, and said control loop.

4. The electronic frame lock as defined in claim 1, wherein said electronic key is a contactless electronic key, and said electronic key transmits said signal to said controller in a contactless fashion.

5. The electronic frame lock as defined in claim 3, wherein said electronic key is a contactless electronic key, and said electronic key transmits said signal to said reader in a contactless fashion.

6. The electronic frame lock as defined in claim 1, wherein said controller is externally connected with a computer or a device similar to the computer via a transmission unit.

7. The electronic frame lock as defined in claim 3, wherein said central processing unit is externally connected with a computer or a device similar to the computer via a transmission unit.
